(19) United States
(12) Patent Application Publication
(10) Pub. No.: US 2026/0167285 A1
(43) Pub. Date: Jun. 18, 2026

(54) Apparatus and Method for Aligning the Idler Rollers of a Continuous Track

(71) Applicant: Terra Drive Systems, Inc., Brookston, IN (US)

(72) Inventor: Lane C. Kirby, West Point, IN (US)

(73) Assignee: Terra Drive Systems, Inc., Brookston, IN (US)

(21) Appl. No.: 19/396,548

(22) Filed: Nov. 21, 2025

Related U.S. Application Data
(60) Provisional application No. 63/734,864, filed on Dec. 17, 2024.

(51) Int. Cl. B62D 55/15; B62D 55/10; B62D 55/104

(52) U.S. Cl. CPC B62D 55/15; B62D 55/10; B62D 55/104

(57) ABSTRACT

An apparatus for adjusting the alignment of idler rollers rotatably mounted on a pivotable axle assembly comprises an alignment member, first and second alignment walls, and first and second alignment bolts. The first and second walls are mounted to a frame and are spaced apart for defining a gap therebetween. The alignment member is coupled to the axle assembly and extends into the gap. The alignment member includes a first threaded bore, and the first wall includes a second threaded bore. The first bolt threadingly engages and extends through the first bore and abuts against the second wall. The second bolt threadingly engages and extends through the second bore and abuts against the alignment member. In operation, the first and second bolts are selectively extended or retracted through the first and second bores for pivoting the alignment member and thereby selectively adjusting the alignment of the idler wheels.

### BACKGROUND OF THE INVENTION

### 1. Field of the Invention

The present invention relates to continuous tracks. More particularly, the present invention is directed to an apparatus and method for aligning the idler rollers of a continuous track.

### 2. Background

Continuous tracks, also known as “continuous track assemblies”, “tracked treads”, “caterpillar tracks”, and “tank tracks”, are often used in vehicles, and, in particular, agricultural vehicles such as carts, trailers, tractors, and harvester combines, to increase traction and reduce ground pressure and soil compaction. For example, agricultural trailers can include a pair of continuous tracks in place of traditional wheels to spread the weight of the trailer across a larger surface area and thereby reduce the pressure on the soil.

Continuous tracks typically comprise a plurality of rollers rotatably secured to a frame and an endless belt supported by and entrained around the rollers. Specifically, continuous tracks typically include a pair of tensioner rollers which are mounted at one end of the continuous track's frame, a pair of idler rollers which are mounted at the other end of the frame, and a plurality of mid-rollers which are mounted to the frame between the tensioner rollers and the idler rollers. The tensioner rollers are coupled to the frame by a tensioner mechanism, also known as a “recoil” mechanism. The tensioner mechanism pushes/drives the idler wheels against the endless belt, taking up any slack and placing the belt under tension.

The idler rollers are coupled to the frame by a pivotable axle assembly which is coupled to an alignment apparatus. The alignment apparatus allows a user to selectively pivot the axle assembly in order to adjust the alignment of the idler rollers and thereby ensure that the belt runs smoothly around and remains aligned with the tensioner rollers and idler rollers.

Traditionally, alignment apparatuses for continuous tracks comprise an alignment member and a pair of bolts. The alignment member is coupled to the pivotable axle assembly and extends horizontally along the track frame with the terminal end thereof extending into a gap between a pair of alignment walls. The alignment walls are mounted to the bottom of the frame, and each includes a threaded bore. The pair of bolts are threaded into and through the threaded bores and engage opposite sides of the alignment member terminal end.

In traditional idler roller alignment apparatuses, the pair of bolts are used to pivot the alignment member, and, hence, the axle assembly and the idler rollers, by rotatingly tightening and thereby extending one of the bolts towards the alignment member terminal end while rotatingly loosening and thereby retracting the other bolt away from the alignment member terminal end. That is, as one bolt is advanced towards the alignment member terminal end, the other bolt is retracted away from the alignment member terminal end. This allows the advancing bolt to drive the alignment member terminal end towards the retracting bolt for thereby rotating/pivoting the axle assembly and the idler rollers. By selectively extending and/or retracting the bolts, a user can fine tune the alignment of the idler rollers in order to ensure the belt runs smoothly around and remains aligned with the tensioner and idler rollers. Examples of traditional idler roller alignment apparatuses are shown and described in Satzler, U.S. Pat. No. 5,127,714; Satzler et al., U.S. Pat. No. 5,286,044; and Brandenburger, U.S. Pat. No. 6,386,653.

However, traditional idler roller alignment apparatuses require access to both sides of the continuous track in order to be adjusted. This increases the amount of time and effort needed to adjust the alignment of the idler rollers. Accordingly, there exists a need for an improved idler roller alignment apparatus which can be selectively adjusted from one side of the continuous track.

### SUMMARY OF THE INVENTION

In a first embodiment thereof, the present invention is directed to an apparatus for adjusting the alignment of idler rollers rotatably mounted on a pivotable axle assembly. The alignment apparatus can comprise an alignment member which can be coupled to the axle assembly, first and second alignment walls which can be mounted to a frame, and first and second alignment bolts. The first and second alignment walls can be spaced apart from each other for defining a gap therebetween, and the alignment member can extend into the gap.

The alignment member can include a first threaded bore and the first alignment wall can include a second threaded bore. The first alignment bolt can be configured to threadingly engage and extend through the first threaded bore and abut against the second alignment wall. The second alignment bolt can be configured to threadingly engage and extend through the second threaded bore and abut against the alignment member. In operation, the first and second alignment bolts can be configured to be selectively extended or retracted through the first and second threaded bores for pivoting the alignment member and the axle assembly and thereby selectively adjusting the alignment of the idler wheels.

Preferably, the alignment member includes a head portion which is coupled to the axle assembly and a base/tiller portion which extends outwardly from the axle assembly into the gap between the first and second alignment walls. The first threaded bore is preferably provided extending through the base/tiller portion adjacent to a terminal end thereof.

Preferably, the alignment apparatus further includes a retaining plate having a pair of polygonal holes. The retaining plate can be selectively secured to the first alignment wall with the polygonal holes received over and engaging the first and second alignment bolts for preventing the first and second alignment bolts from rotatingly loosening.

Yet more preferably, the first and second alignment bolts each include a hexagonal head having flat tool surfaces. The polygonal holes are preferably rectangular-shaped and include flat hole surfaces which are configured to engage and abut against the flat tool surfaces when the retaining plate is secured to the first alignment wall.

In a second embodiment thereof, the present invention is directed to a continuous track assembly. The continuous track assembly can comprise a frame, an axle assembly pivotably mounted to the frame, one or more idler rollers rotatably mounted to the axle assembly, and an alignment apparatus for adjusting the alignment of the one or more idler rollers. The alignment apparatus can comprise an alignment member which can be coupled to the axle assembly, first and second alignment walls which can be mounted to the frame, and first and second alignment bolts. The first and second alignment walls can be spaced apart from each other for defining a gap therebetween, and the alignment member can extend into the gap.

The alignment member can include a first threaded bore and the first alignment wall can include a second threaded bore. The first alignment bolt can be configured to threadingly engage and extend through the first threaded bore and abut against the second alignment wall. The second alignment bolt can be configured to threadingly engage and extend through the second threaded bore and abut against the alignment member. In operation, the first and second alignment bolts can be configured to be selectively extended or retracted through the first and second threaded bores for pivoting the alignment member and the axle assembly and thereby selectively adjusting the alignment of the idler wheels.

Preferably, the continuous track assembly includes an exterior side and an interior side. The first and second alignment bolts can each include a head which is configured to be engaged by a tool for rotatingly tightening or loosening the first and second alignment bolts. In this regard, the first and second alignment bolts are preferably threaded into the first and second threaded bores with the heads of the first and second alignment bolts located on the exterior side of the continuous track assembly.

Preferably, the continuous track assembly further includes a retaining plate having a pair of polygonal holes. The retaining plate is configured to be selectively secured to the first alignment wall with the polygonal holes received over and engaging the heads of the first and second alignment bolts for preventing the first and second alignment bolts from rotatingly loosening during operation of the continuous track assembly.

In a third embodiment thereof, the present invention is directed to a method for aligning one or more idler rollers of a continuous track. The continuous track can comprise a frame, an axle assembly pivotably mounted to the frame, one or more idler rollers rotatably mounted to the axle assembly, and an alignment apparatus for adjusting the alignment of the one or more idler rollers. The alignment apparatus can comprise an alignment member which can be coupled to the axle assembly, first and second alignment walls which can be mounted to the frame, and first and second alignment bolts. The first and second alignment walls can be spaced apart from each other for defining a gap therebetween, and the alignment member can extend into the gap.

The alignment member can include a first threaded bore and the first alignment wall can include a second threaded bore. The first alignment bolt can be configured to threadingly engage and extend through the first threaded bore and abut against the second alignment wall. The second alignment bolt can be configured to threadingly engage and extend through the second threaded bore and abut against the alignment member.

The method can comprise the steps of rotatingly loosening/retracting one of the first and second alignment bolts through one of the first and second threaded bores and selectively rotatingly tightening/extending the other of the first or second alignment bolts through the other of the first or second threaded bores. As the first or second alignment bolt is selectively rotatingly tightened/extending through the first or second threaded bore, the alignment member is pushed or pulled towards or away from the second alignment wall for thereby pivoting the axle assembly and selectively adjusting the alignment of the idler rollers.

Preferably, the continuous track includes an interior side and an exterior side and the steps of rotatingly loosening/retracting one of the first and second alignment bolts and selectively rotatingly tightening/extending the other of the first or second alignment bolts are both performed from the exterior side of the continuous track.

Preferably, after the step of rotatingly tightening/extending the first or second alignment bolt, the first or second alignment bolt which had been rotatingly loosened is then rotatingly tightened/extended and engages the alignment member for thereby clampingly securing the alignment member in position.

Yet more preferably, the alignment apparatus further includes a retaining plate having a pair of polygonal holes. After the first or second alignment bolt which had been rotatingly loosened is rotatingly tightened/extended for thereby clampingly securing the alignment member in position, the retaining plate can selectively be secured to the first alignment wall with the polygonal holes received over and engaging the first and second alignment bolts for preventing first and second alignment bolts from rotatingly loosening during operation of the continuous track.

### BRIEF DESCRIPTION OF THE DRAWINGS

The above-mentioned and other features of this invention and the manner of attaining them will become more apparent, and the invention itself will be better understood by reference to the following description of the embodiments of the invention, taken in conjunction with the accompanying drawings, wherein:

FIG. 1A is a perspective view of a continuous track installed on an agricultural trailer;

FIG. 1B is a magnified detail view of Circled Detail 1B shown in FIG. 1A;

FIG. 2 is a perspective view of the continuous track shown in FIG. 1A wherein the endless belt/track and an idler roller have been removed for greater clarity;

FIG. 3A is an exploded perspective view of the continuous track;

FIG. 3B is a magnified detail view of Circled Detail 3B shown in FIG. 3A;

FIG. 4A is a bottom plan view of the continuous track wherein part of the endless belt/track has been cut away to show the alignment apparatus;

FIG. 4B is a magnified detail view of Circled Detail 4B shown in FIG. 4A;

FIG. 4C is an exploded detail view of Circled Detail 4B;

FIG. 5 is a side elevation view showing the idler roller end of the continuous track;

FIG. 6A is a first cross-section view of the continuous track taken along the line 6-6 shown in FIG. 5 illustrating the alignment member being pivoted in a clockwise direction;

FIG. 6B is a magnified detail view of Circled Detail 6B shown in FIG. 6A;

FIG. 7A is a second cross-section view of the continuous track taken along the line 6-6 shown in FIG. 5 illustrating the alignment member being pivoted in a counterclockwise direction;

FIG. 7B is a magnified detail view of Circled Detail 7B shown in FIG. 7A;

FIG. 8A is a third cross-section view of the continuous track taken along the line 6-6 shown in FIG. 5 illustrating the alignment member being clampingly secured in position by the alignment bolts;

FIG. 8B is a magnified detail view of Circled Detail 8B-C shown in FIG. 8A illustrating the first alignment bolt being rotatingly tightened for clampingly securing the alignment member in position; and

FIG. 8C is a magnified detail view of Circled Detail 8B-C illustrating the second alignment bolt being rotatingly tightened for clampingly securing the alignment member in position.

Corresponding reference characters indicate corresponding parts throughout several views. Although the exemplification set out herein illustrates certain embodiments of the invention, the embodiments disclosed below are not intended to be exhaustive or to be construed as limiting the scope of the invention to the precise form disclosed.

### DETAILED DESCRIPTION OF THE PREFERRED EMBODIMENTS

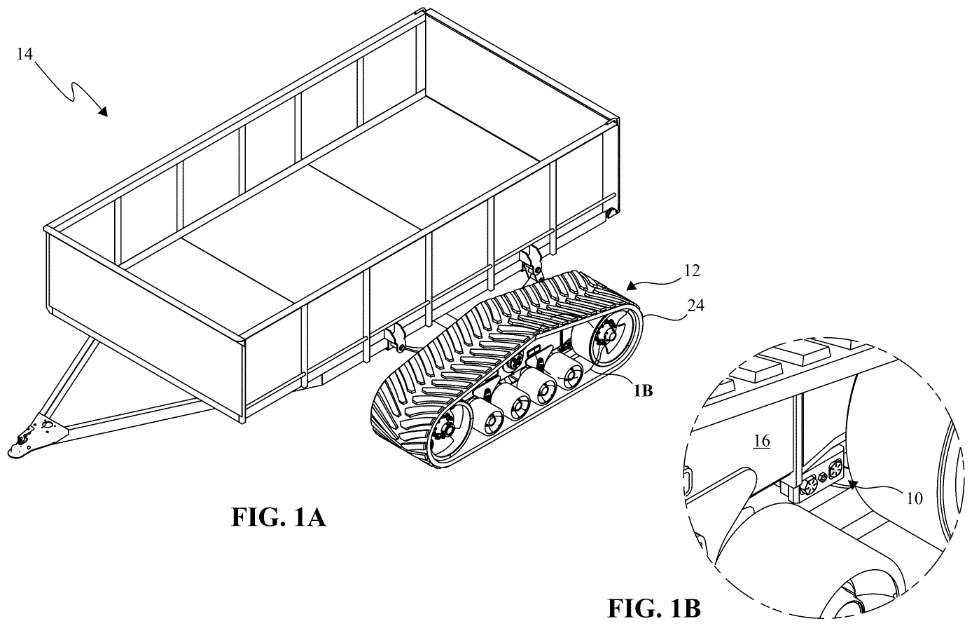

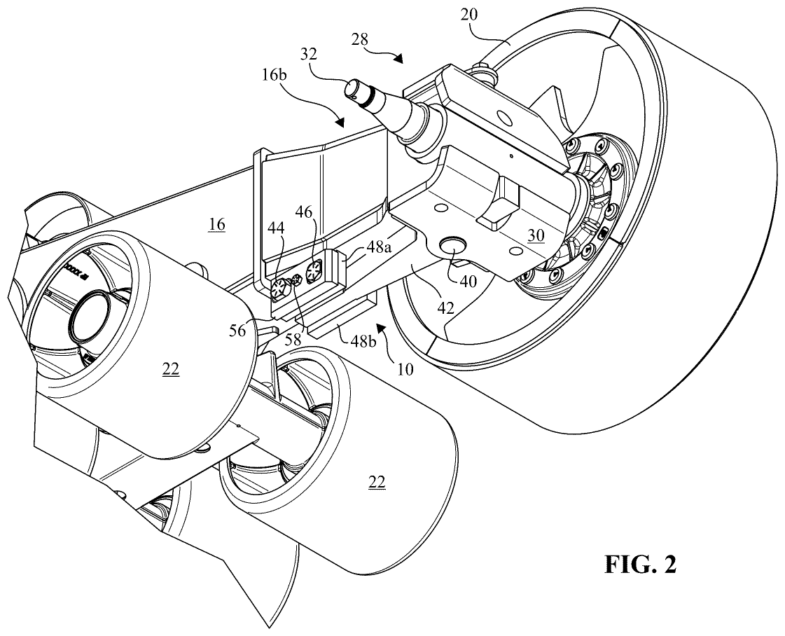

Referring initially to FIGS. 1-3, an alignment apparatus constructed in accordance with the principles of the present invention is shown and designated by the numeral 10. The alignment apparatus 10 is adapted to be installed on a continuous track 12 of a land vehicle 14, such as, for example, an agricultural trailer. The continuous track 12 comprises a frame 16 having a first frame end 16a and a second frame end 16b, a pair of tensioner rollers 18 which are rotatably mounted at the first frame end 16a, a pair of idler rollers 20 which are rotatably mounted at the second frame end 16b, one or more mid-rollers 22 which are rotatably mounted to the frame 16 between the tensioner and idler rollers 18, 20, and an endless belt/track 24 which is entrained around and supported by the rollers 18, 20, 22. The tensioner rollers 18 are coupled to the first frame end 16a by a tensioning mechanism (not shown). The tensioning mechanism biases the tensioner rollers 18 away from the frame 16 for thereby placing the endless belt/track 24 of the continuous track 12 under tension.

The idler rollers 20 are rotatably mounted on an axle assembly 28 which is pivotably mounted to the frame 16. The alignment apparatus 10 is coupled to the axle assembly 28 and is used for selectively pivoting the axle assembly 28. By selectively pivoting the axle assembly 28, the alignment apparatus 10 can be used to adjust and fine-tune the alignment between the idler rollers 20 and the tensioner and mid-rollers 18, 22 to ensure the endless belt/track 24 runs smoothly around and remains aligned with the each of the rollers 18, 20, 22.

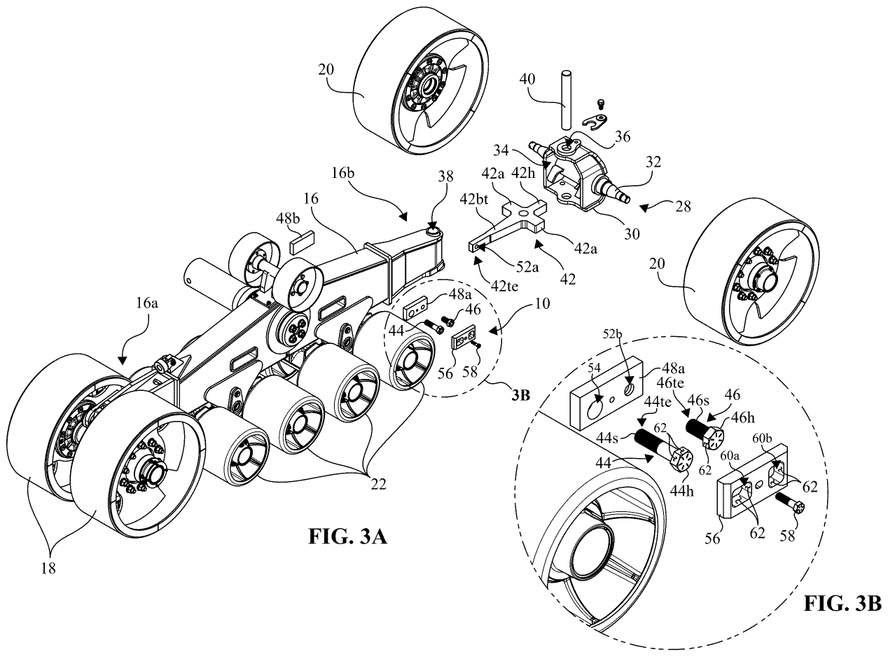

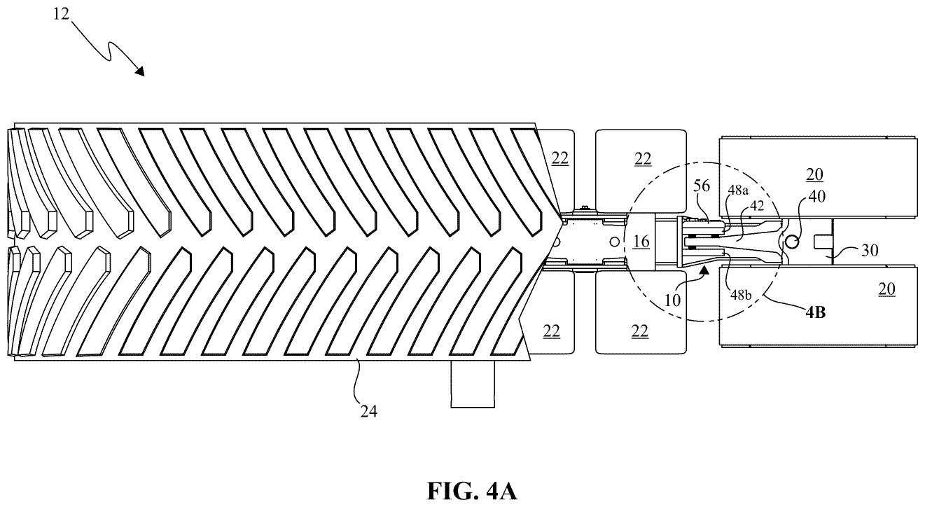

As best seen in FIG. 3A, the axle assembly 28 comprises a housing 30. An axle 32 is secured to the housing 30 and the idler rollers 20 are rotatably mounted on the axle 32 preferably one on either side of the housing 30. The housing 30 is, preferably, constructed from a plurality of pre-cut and/or stamped or bent steel plates which are secured together to form a half-box shaped structure. The housing 30 includes an open cavity 34 which is sized to receive the second frame end 16b. The housing 30 also includes a vertical pivot bore 36 which extends vertically through the housing 30 and the open cavity 34.

The second frame end 16b includes a vertical frame bore 38 which is configured to be aligned with the vertical pivot bore 36. The housing 30, and, hence, the axle assembly 28, is pivotably mounted to the frame 16 by aligning the bores 36, 38 and inserting a cylindrical king pin 40 therethrough. In operation, the axle assembly 28, and the idler rollers 20 mounted thereto, are selectively pivoted around cylindrical king pin 40, via the alignment apparatus 10, for thereby adjusting the alignment of the idler rollers 20.

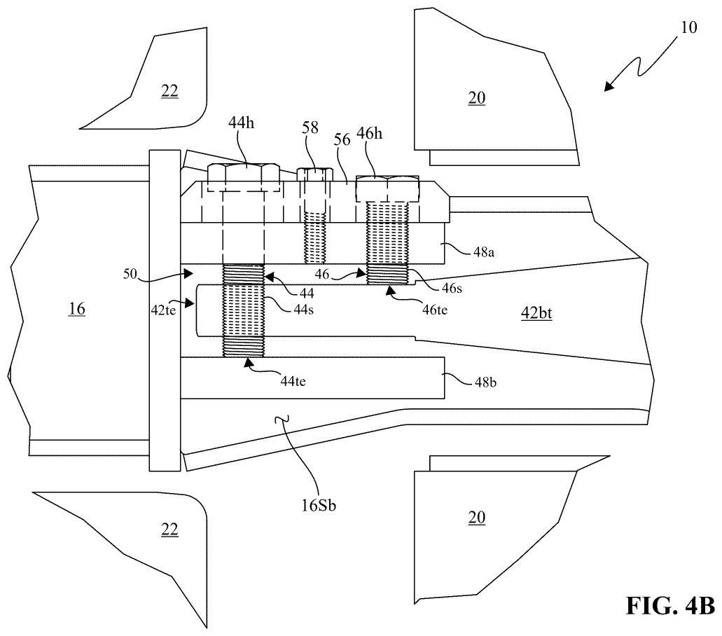

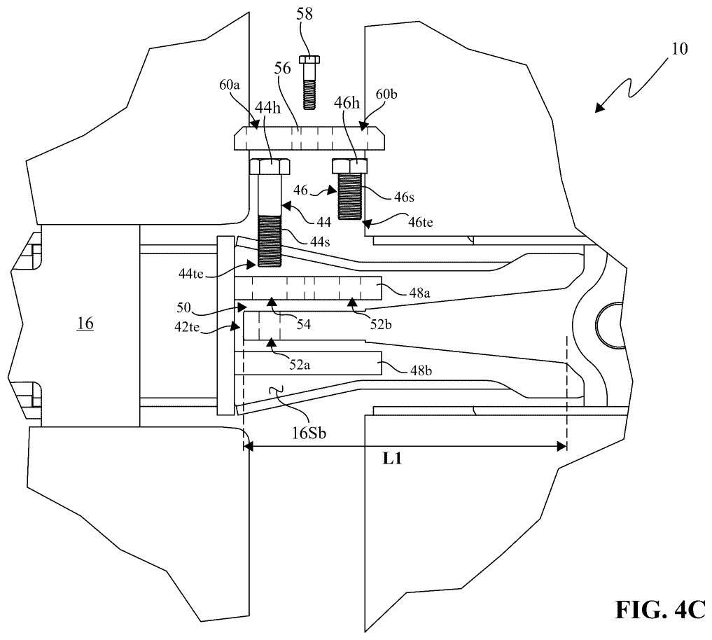

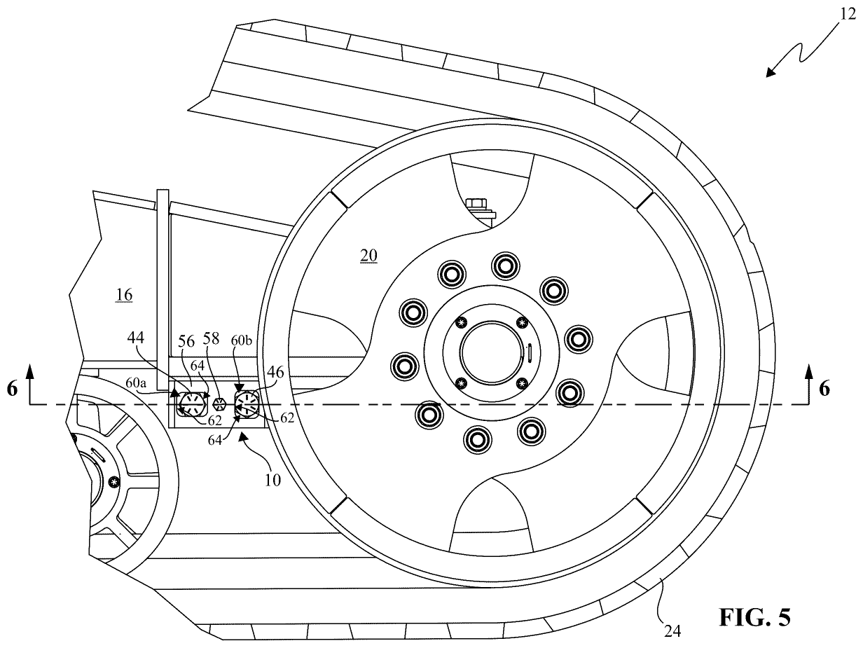

Turning to FIGS. 4-8, in the present exemplary embodiment, the alignment apparatus 10 comprises a cross-shaped alignment member 42 and a pair of alignment bolts 44, 46. The cross-shaped alignment member 42 includes a head portion 42h, a pair of arm portions 42a, and an elongated base/tiller portion 42bt. The head and arm portions 42h, 42a of the alignment member 42 are secured to the housing 30. The elongated base/tiller portion 42bt extends outwardly from the housing 30, preferably parallel to and along the bottom surface 16Sb of the frame 16. The terminal end 42te of the base/tiller portion 42bt includes a first threaded bore 52a which extends through the base/tiller portion terminal end 42te preferably perpendicular to the longitudinal length L1 (FIG. 4C) of the base/tiller portion 42bt.

A pair of alignment walls 48a, 48b are rigidly mounted to the bottom surface 16Sb of the frame 16 inboard of the second frame end 16b. The alignment walls 48a, 48b are located one on either side of the frame 16 and define a gap 50 therebetween. The terminal end 42te of the base/tiller portion 42bt extends into the gap 50. The first alignment wall 48a includes a second threaded bore 52b and a clearance bore 54 which extend through the alignment wall 48a and open into the gap 50. The clearance bore 54 is positioned such that it aligns with the first threaded bore 52a.

The first alignment bolt 44 is adapted to be received through the clearance bore 54 and threadingly engage the first threaded bore 52a and the second alignment bolt 46 is adapted to threadingly engage the second threaded bore 52b. Preferably, the clearance bore 54 is sized such that there is space for the first alignment bolt 44 to pivot and move within the clearance bore 54 during operation of the alignment apparatus 10.

During assembly, the first alignment bolt 44 is rotatingly threaded through the first threaded bore 52a until the terminal end 44te of the bolt 44 abuts against the second alignment wall 48b. Similarly, the second alignment bolt 46 is rotatingly threaded through the second threaded bore 52b until the terminal end 46te of the second alignment bolt 46 abuts against the alignment member base/tiller portion 42bt on the opposite side from the second alignment wall 48b.

Preferably, the alignment apparatus 10 also includes a retainer plate 56 which can be selectively secured to the first alignment wall 48a by a fastener 58. The retainer plate 56 includes a pair of polygonal holes 60a, 60b which are, preferably, rectangular. The rectangular holes 60a, 60b are adapted to engage the heads 44h, 46h of the alignment bolts 44, 46 to prevent the alignment bolts 44, 46 from rotatingly loosening during operation of the land vehicle 14. Specifically, the bolts 44, 46 are preferably hex-head bolts comprising hexagonal heads 44h, 46h and threaded shanks 44s, 46s extending therefrom. The threaded shanks 44s, 46s are configured to threadingly engage the first and second threaded bores 52a, 52b. The heads 44h, 46h are adapted to be engaged by a tool, such as, for example, a socket wrench (not shown), which can be used for rotatingly tightening or loosening the bolts 44, 46. The retainer plate rectangular holes 60a, 60b are sized to receive the heads 44h, 46h and include one or more flat hole surfaces 62 which are configured to engage flat tool surfaces 64 located around the perimeter of the hexagonal heads 44h, 46h. This engagement between the flat hole surfaces 62 and the flat tool surfaces 64 locks the bolts 44, 46 in position and prevents them from rotatingly loosening during operation of the land vehicle 14.

Preferably, the rectangular hole 60a is generally slot-shaped and is configured to engage the head 44h of the first alignment bolt 44. The rectangular hole 60a is slot shaped such that the head 44h of the first alignment bolt 44 can be received into the rectangular hole 60a even if the bolt 44 extends through the clearance bore 54 at an angle due to the angle/position of the base/tiller portion 42bt. Specifically, as mentioned above, the base/tiller portion 42bt includes a first threaded bore 52a which perpendicularly through the terminal end 42te of the base/tiller portion 42bt. When the bolts 44, 46 are used to pivot and change the position of the base/tiller portion 42bt, the first alignment bolt 44, which threadingly engages and extends coaxially through the first threaded bore 52a, will pivot slightly and will not necessarily always extend coaxially through the clearance bore 54 of the first alignment wall 48a. Accordingly, the rectangular hole 60a is configured to be slot-shaped to ensure that, even if the first alignment bolt 44 is not extending coaxially through the clearance bore 54, the head 44h of the bolt 44 will still be received into and engage the flat hole surfaces 62 of the rectangular hole 60a for thereby preventing the bolt 44 from rotatingly loosening during operation of the land vehicle 14.

In operation, the retainer plate 56 is removed and the first and second alignment bolts 44, 46 are used to selectively pivot the base/tiller portion 42bt back and forth within the gap 50 for thereby selectively pivoting the axle assembly 28, and, hence, the idler rollers 20, around the cylindrical king pin 40. Specifically, the alignment apparatus 10 is used by first removing the retainer plate 56 for thereby releasing the heads 44h, 46h from the rectangular holes 60a, 60b. One of the bolts 44, 46 is then rotatingly loosened and thereby retracted and the other bolt 44, 46 is rotatingly tightened and thereby extended for pushing or pulling the alignment member 42 in a counterclockwise or clockwise direction.

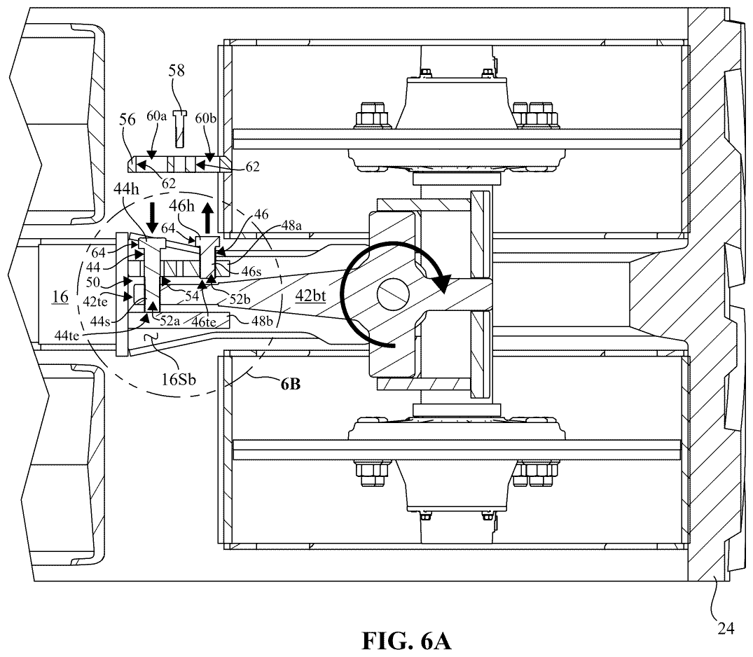

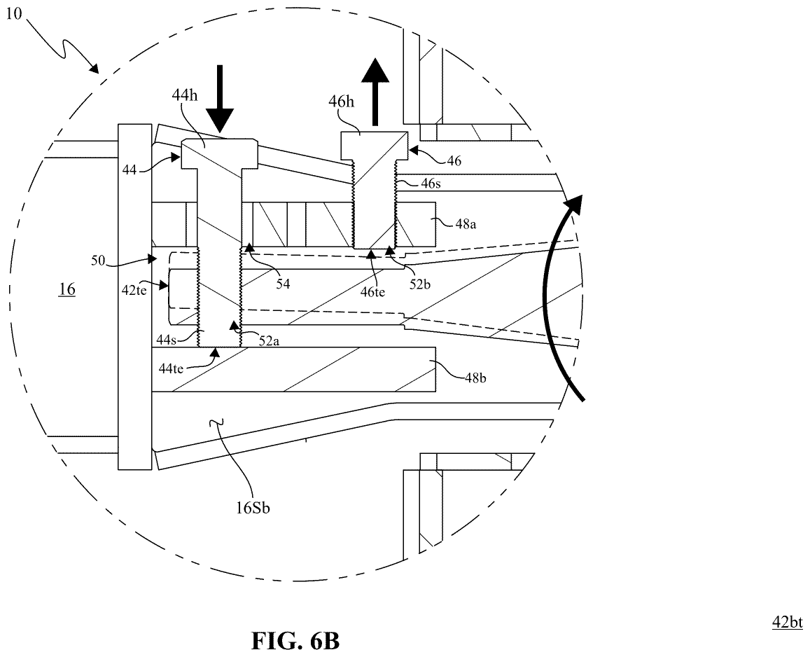

For example, as shown in FIGS. 6A-B, to pivot the base/tiller portion 42bt, and, hence, the axle assembly 28 and the idler rollers 20, in a clockwise direction, the second alignment bolt 46 is rotatingly loosened and retracted through the second threaded bore 52b whereby the terminal end 46te thereof is retracted away from the base/tiller portion terminal end 42te. The first alignment bolt 44 is then rotatingly tightened and extended through the first threaded bore 52a. As the first alignment bolt 44 is rotatingly tightened and extended through the first threaded bore 52a, the terminal end 42te of the bolt 44 abuts against and is held in place by the second alignment wall 48b. Because the terminal end 44te of the bolt 44 is held in place by the second alignment wall 48b, the bolt 44 acts like a screw jack whereby continuing to rotatingly tighten and extend the bolt 44 through the first threaded bore 52a pulls the base/tiller portion 42bt away from second alignment wall 48b and thereby pivots the base/tiller portion 42bt in a clockwise direction.

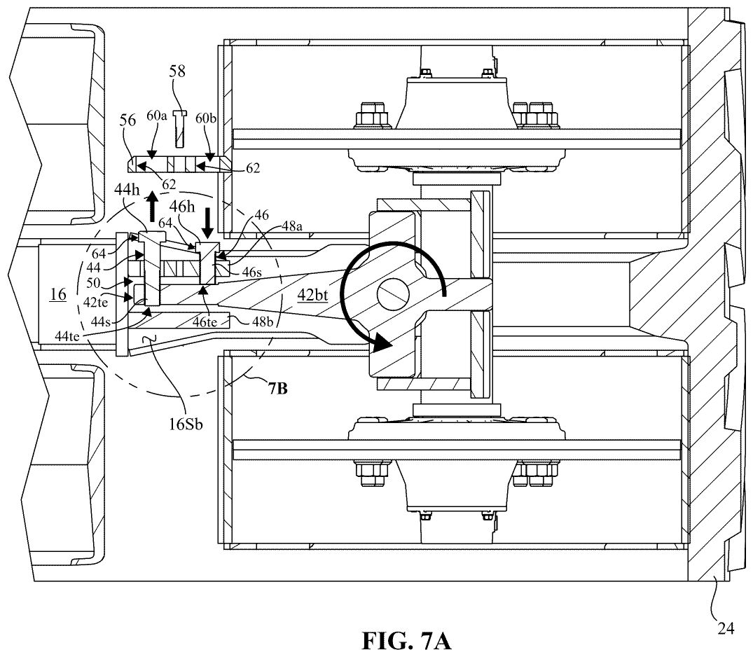

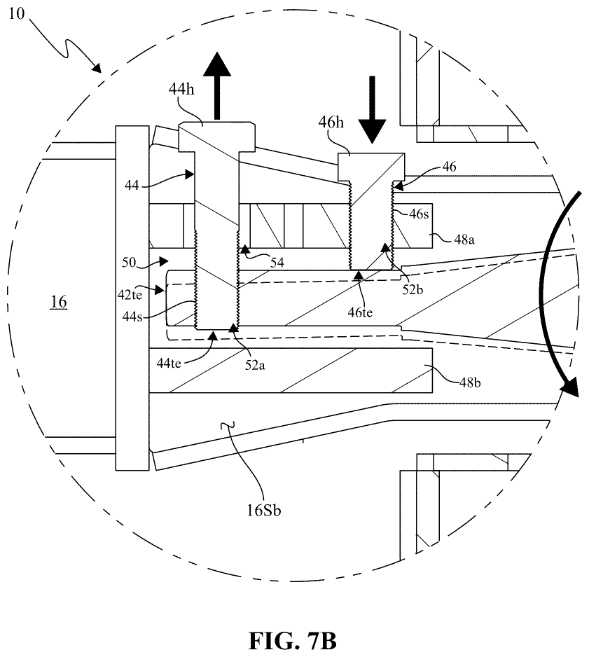

As shown in FIGS. 7A-B, to pivot the base/tiller portion 42bt in a counterclockwise direction, the first alignment bolt 44 is rotatingly loosened and retracted through the first threaded bore 52b away from the second alignment wall 48b. The second alignment bolt 46 is then rotatingly tightened and extended through the second threaded bore 52b. As the second alignment bolt 46 is rotatingly tightened, the terminal end 42te of the bolt 46 is driven against and pushes the base/tiller portion 42bt in a counterclockwise direction towards the second alignment wall 48b.

Once the base/tiller portion 42bt, and, hence, the axle assembly 28 and the idler rollers 20, have been positioned as desired, the alignment bolts 44, 46 are then used to clampingly secure the base/tiller portion 42bt, and, hence, the axle assembly 28 and the idler rollers 20, in position. Specifically, once the base/tiller portion 42bt is in the desired position, whichever bolt 44, 46 had been rotatingly loosened to allow the base/tiller portion 42bt to pivot is rotatingly tightened and applies a first force F1 to the base/tiller portion 42bt. As the bolt 44, 46 is rotatingly tightened, the other bolt 44, 46 applies a reaction force F2 to base/tiller portion 42bt which opposes the first force F1 for thereby clampingly securing the base/till portion 42bt in position.

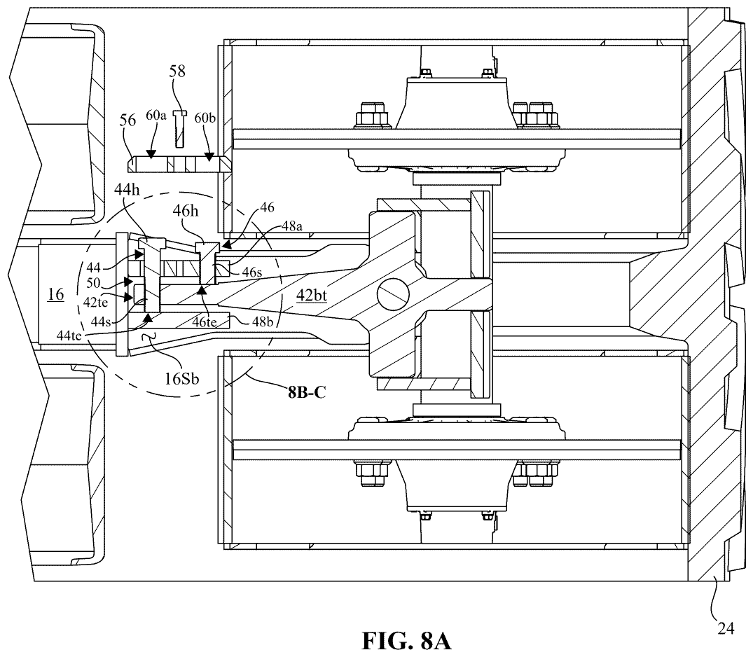

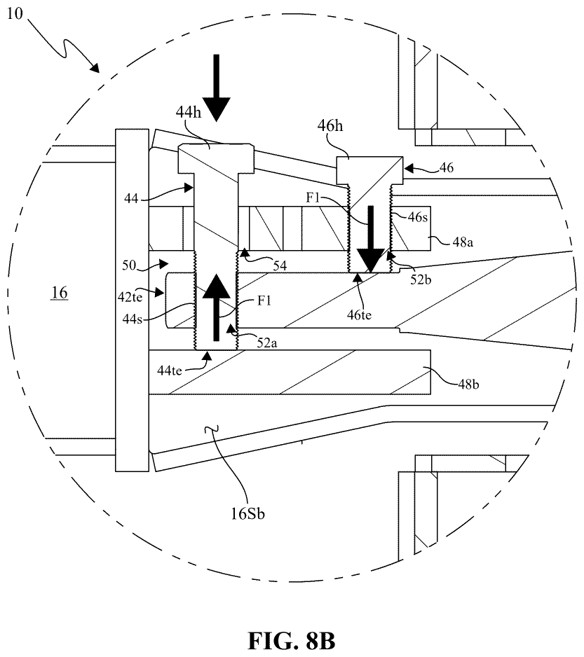

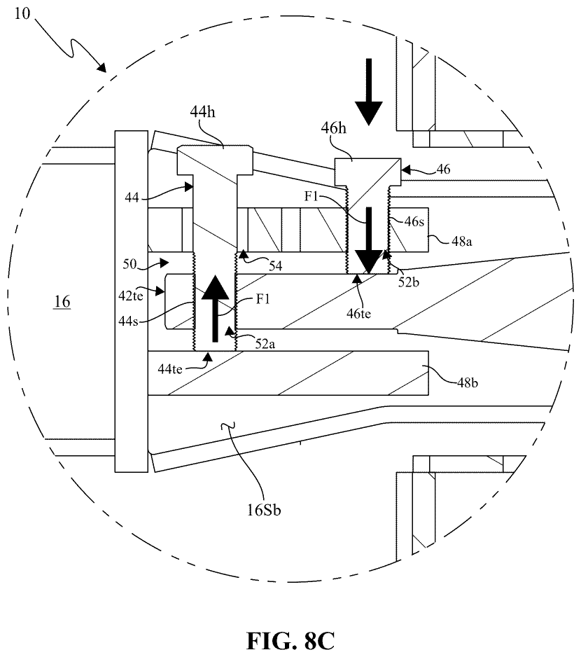

For example, as shown in FIGS. 8A-B, if the bolts 44, 46 were used as described hereinabove to pivot the base/tiller portion 42bt in a counterclockwise direction towards the second alignment wall 48b, once the base/tiller portion 42bt has been pushed into the desired position by the second alignment bolt 46, the first alignment bolt 44 is rotatingly tightened and extended until the first bolt terminal end 44te is against/abutting the second alignment wall 48b. The first alignment bolt 44 is then further rotatingly tightened and applies a pulling force F1 to the base/tiller portion 42bt. The pulling force F1 pulls the base/tiller portion 42bt towards and against the second alignment bolt 46. The second alignment bolt 46 is prevented from retracting away base/tiller portion 42bt by its threaded engagement with the second threaded bore 52b. So, as the first bolt 44 is rotatingly tightened, the second bolt 46 applies a reaction force F2 to the base/tiller portion 42bt opposing the pulling force F1 and thereby clampingly securing the base/tiller portion 42bt, and, hence, the axle assembly 28 and the idler rollers 20, in position. The retainer plate 56 can then be reinstalled for preventing the bolts 44, 46 from rotatingly loosening during operation of the land vehicle 14.

Similarly, as shown in FIG. 8C, if the bolts 44, 46 were used to pivot the base/tiller portion 42bt in a clockwise direction towards the first alignment wall 48a, once the base/tiller portion 42bt has been pulled into the desired position by the first alignment bolt 44, the second alignment bolt 46 is rotatingly tightened and extended until the second bolt terminal end 46te is against/abutting the base/tiller portion 42bt. The second alignment bolt 46 is then further rotatingly tightened and applies a pushing force F1 to base/tiller portion 42bt which pushes the base/tiller portion 42bt towards the second alignment wall 48b. The pushing force F1 is transferred to the first alignment bolt 44 through its threaded engagement with the base/tiller first threaded bore 52a and drives the first bolt terminal end 44te against the second alignment wall 48b. Of course, as mentioned above, the second alignment wall 48b is rigidly mounted to the frame 16. Accordingly, as the first bolt terminal end 44te is driven against the second alignment wall 48b, a reaction force F2 is applied to the base/tiller portion 42bt opposing the pushing force F1 and thereby clampingly base/tiller portion 42bt, and, hence, the axle assembly 28 and the idler rollers 20, in position.

Preferably, the alignment apparatus 10 is configured such that, when the continuous track 12 is mounted to a land vehicle 14, the first alignment wall 48a is located towards, and is readily accessible from, the exterior side of the vehicle 14. Specifically, as best seen in FIGS. 1A-B and 5, the first alignment wall 48a is preferably mounted on the exterior side of the continuous track 12 (i.e., the side of the continuous track 12 that faces away from the land vehicle 14) whereby the first and second alignment bolts 44, 46 are both readily accessible from the exterior side of the land vehicle 14. Configuring the alignment apparatus 10 such that the first and second alignment bolts 44, 46 are both readily accessible from the exterior side of the land vehicle 14 makes it significantly easier to make adjustments to the alignment of the idler rollers 20 and allows adjustments to be made without needing to bring the land vehicle 14 in for servicing.

Unless otherwise indicated hereinabove, the alignment member 42, the alignment walls 48a, 48b, the alignment bolts 44, 46, and the retainer plate 56 are preferably constructed from a high-strength metallic material, such as, for example, steel, aluminum, or other high-strength metals.

While this invention has been described as having an exemplary design, the present invention may be further modified within the spirit and scope of this disclosure. This application is therefore intended to cover any variations, uses, or adaptations of the invention using its general principles.

What is claimed is:

1. An apparatus for adjusting the alignment of idler rollers rotatably mounted on a pivotable axle assembly, the apparatus comprising:
an alignment member coupled to and extending from the axle assembly, the alignment member having a first threaded bore;
first and second alignment walls which are mounted to a frame and are spaced apart from each other for defining a gap therebetween, wherein the alignment member extends into the gap and the first alignment wall includes a second threaded bore;
a first alignment bolt which threadingly engages and extends through the first threaded bore and abuts the second alignment wall; and
a second alignment bolt which threadingly engages and extends through the second threaded bore and abuts the alignment member;
wherein the first and second alignment bolts are configured to be selectively extended or retracted through the first and second threaded bores for pivoting the alignment member and the axle assembly and thereby selectively adjusting the alignment of the idler wheels.

2. The alignment apparatus of claim 1, wherein the alignment member includes a head portion which is coupled to the axle assembly and a base/tiller portion which extends outwardly from the axle assembly into the gap between the first and second alignment walls.

3. The alignment apparatus of claim 2, wherein the first threaded bore is provided extending through the base/tiller portion adjacent to a terminal end thereof.

4. The alignment apparatus of claim 1 further comprising a retaining plate having a pair of polygonal holes, wherein the retaining plate is selectively secured to the first alignment wall with the polygonal holes received over and engaging the first and second alignment bolts for preventing the first and second alignment bolts from rotatingly loosening.

5. The alignment apparatus of claim 4, wherein the first and second alignment bolts each include a hexagonal head having flat tool surfaces, wherein the polygonal holes are rectangular-shaped and include flat hole surfaces, and wherein the flat hole surfaces are configured to engage and abut against the flat tool surfaces when the retaining plate is secured to the first alignment wall.

6. A continuous track assembly comprising:
a frame;
an axle assembly pivotably mounted to the frame;
one or more idler rollers rotatably mounted to the axle assembly; and,
an alignment apparatus for adjusting the alignment of the one or more idler rollers, the alignment apparatus comprising:
an alignment member coupled to and extending from the axle assembly, the alignment member having a first threaded bore;
first and second alignment walls mounted to the frame and spaced apart from each other for defining a gap therebetween, wherein the alignment member extends into the gap, and wherein the first alignment wall includes a second threaded bore;
a first alignment bolt which threadingly engages and extends through the first threaded bore and abuts the second alignment wall; and
a second alignment bolt which threadingly engages and extends through the second threaded bore and abuts the alignment member;
wherein the first and second alignment bolts are configured to be selectively extended or retracted through the first and second threaded bores for pivoting the alignment member and the axle assembly and thereby selectively adjusting the alignment of the idler wheels.

7. The continuous track assembly of claim 6, wherein the continuous track assembly includes an exterior side and an interior side, wherein the first and second alignment bolts each include a head which is configured to be engaged by a tool for rotatingly tightening or loosening the first and second alignment bolts, and wherein the first and second alignment bolts are threaded into the first and second threaded bores with the heads of the first and second alignment bolts located on the exterior side of the continuous track assembly.

8. The continuous track assembly of claim 7 further comprising a retaining plate having a pair of polygonal holes, wherein the retaining plate is selectively secured to the first alignment wall with the polygonal holes received over and engaging the heads of the first and second alignment bolts for preventing the first and second alignment bolts from rotatingly loosening during operation of the continuous track assembly.

9. A method for aligning one or more idler rollers of a continuous track, the continuous track comprising:
a frame;
an axle assembly pivotably mounted to the frame, wherein the one or more idler rollers are rotatably mounted to the axle assembly; and,
an alignment apparatus for adjusting the alignment of the one or more idler rollers, the alignment apparatus comprising:
first and second alignment walls mounted to the frame and spaced apart from each other for defining a gap therebetween, the first alignment wall having a first threaded bore;
an alignment member coupled to axle assembly and extending into the gap between the first and second alignment walls, the alignment member having a second threaded bore;
a first alignment bolt which threadingly engages and extends through the first threaded bore and abuts the alignment member; and
a second alignment bolt which threadingly engages and extends through the second threaded bore and abuts the second alignment wall;
the method comprising the steps of:
rotatingly loosening/retracting one of the first and second alignment bolts through one of the first and second threaded bores; and,
selectively rotatingly tightening/extending the other of the first or second alignment bolts through the other of the first or second threaded bores;
wherein as the first or second alignment bolt is selectively rotatingly tightened/extending through the first or second threaded bore, the alignment member is pushed or pulled towards or away from the second alignment wall for thereby pivoting the axle assembly and selectively adjusting the alignment of the idler rollers.

10. The method of claim 9, wherein after the step of rotatingly tightening/extending the first or second alignment bolt, the first or second alignment bolt which had been rotatingly loosened is then rotatingly tightened/extended and engages the alignment member for thereby clampingly securing the alignment member in position.

11. The method of claim 10, wherein the alignment apparatus further includes a retaining plate having a pair of polygonal holes which are configured to be received over and engage the first and second alignment bolts, and wherein after the first or second alignment bolt which had been rotatingly loosened is rotatingly tightened/extended for thereby clampingly securing the alignment member in position, the retaining plate is selectively secured to the first alignment wall with the polygonal holes received over and engaging the first and second alignment bolts for preventing first and second alignment bolts from rotatingly loosening during operation of the continuous track.

12. The method of claim 9, wherein the continuous track includes an interior and an exterior side, and wherein the steps of rotatingly loosening/retracting one of the first and second alignment bolts and selectively rotatingly tightening/extending the other of the first or second alignment bolts are both performed from the exterior side of the continuous track.
